(19) United States
(12) Patent Application Publication
(10) Pub. No.: US 2011/0254746 A1
(43) Pub. Date: Oct. 20, 2011

(54) TRANSMISSION LINE AND ANTENNA FOR VEHICLE

(75) Inventors: Wee Sang Park, Gyeongsangbuk-do (KR); Dae Woong Woo, Gyeongsangbuk-do (JP); Jae Hee Kim, Gyeongsangbuk-do (KR)

(73) Assignee: POSTECH Academy-Industry Foundation, Gyeongsangbuk (KR)

(21) Appl. No.: 13/122,012

(22) PCT Filed: Oct. 25, 2010
(86) PCT No.: PCT/KR10/07333

§ 371 Date: Mar. 31, 2011

(30) Foreign Application Priority Data
Feb. 11, 2009 (KR) 10-2009-0104870

(51) Int. Cl. H01Q 1/32; H01P 3/10

(52) U.S. Cl. 343/713; 333/236

(57) ABSTRACT

A transmission line for a vehicle includes: a steel plate for forming a body of a vehicle; a dielectric formed on the steel plate; and a conductive line formed on the dielectric. An antenna for a vehicle includes: a steel plate for forming a body of a vehicle; a dielectric formed on the steel plate; and a conductive line formed on the dielectric in such a manner as to include a radiating structure.

### TECHNICAL FIELD

The present invention relates to a transmission line and antenna for a vehicle, and, more particularly, to a transmission line and antenna using the body of a vehicle.

### BACKGROUND ART

As the functions of a vehicle become more responsive to consumer requirements, a vehicle structure becomes more complicated due to a large number of electronic devices.

An electrical internal structure of such a vehicle is composed of an antenna for radiating radio signals into a space or receiving radio signals from the space, a transmission line serving to transmit radio signals or electric power, an electronic device for controlling various functions of the vehicle or providing various information to a driver, and the like.

Wires such as an unshielded twisted pair (UTP) cable, a parallel wire, and the like, are mainly employed as the transmission line. As the electronic devices increases, the number of transmission lines made up of the wires increases. This causes a problem of requiring a large internal space and having a complicated wiring structure. One of examples of conventional methods for simplifying a wiring structure is disclosed in KR Application No. 10-2005-0112459, filed on Nov. 23, 2005, entitled “Apparatus for planning wiring harness using durable length and method for operating the method”.

However, the wiring structure should be taken into account whenever developing a vehicle of a new model, and an effort to simplify the wiring structure may result in an increase in the development cost and development period of a vehicle.

Moreover, a vehicle antenna usually uses a small-size antenna to minimize its occupying space. This small-size antenna is problematic in that it cannot adapt itself to various radio wave environments because its pattern is close to non-directional due to its small electric size.

### DISCLOSURE OF INVENTION

### Technical Problem

In view of the above, the present invention provides a transmission line having a very simple structure, which uses the body of a vehicle.

Further, the present invention provides an antenna not only having a very simple structure due to a radiation structure using the body of a vehicle but also adapting itself to various radio wave environments.

### Solution to Problem

In accordance with a first aspect of the present invention, there is provided a transmission line for a vehicle including: a steel plate for forming a body of a vehicle; a dielectric formed on the steel plate; and a conductive line formed on the dielectric.

In accordance with a second aspect of the present invention, there is provided a transmission line for a vehicle including: a steel plate for forming a body of a vehicle; a dielectric formed on the steel plate; a conductive line formed within the dielectric; and a conductor formed on the dielectric.

In accordance with a third aspect of the present invention, there is provided an antenna for a vehicle including: a steel plate for forming a body of a vehicle; a dielectric formed on the steel plate; and a conductive line formed on the dielectric in such a manner as to include a radiating structure.

In accordance with a fourth aspect of the present invention, there is provided an antenna for a vehicle including: a steel plate for forming a body of a vehicle; a dielectric formed on the steel plate; a conductive line formed inside the dielectric; and a conductor formed on the dielectric, wherein at least one of the conductive line and the conductor has a radiating structure.

In accordance with a fifth aspect of the present invention, there is provided an antenna for a vehicle including: a steel plate for forming a body of a vehicle; a conductive line exposed to an exterior and an interior of the body of the vehicle via through apertures penetrating the steel plate; and a dielectric formed between the conductive line at the exterior and the steel plate and between the conductive line at the interior and the steel plate, wherein the conductive line is formed in such a manner as to include a radiating structure in a region exposed to the exterior and a region exposed to the interior.

### ADVANTAGEOUS EFFECTS OF INVENTION

In accordance with the embodiments of the present invention, a transmission line having a very simple structure using the body of a vehicle is provided and thus can be commonly applied regardless of a vehicle model change. Accordingly, there is no need to make an effort for a wiring structure when developing a new vehicle model, thereby reducing the development cost and development period of a vehicle.

Further, it is easy to design a directional antenna with minimum size limitations by providing an antenna not only having a very simple structure due to a radiation structure using the body of a vehicle, but also being capable of adapting itself to various radio wave environments. In addition, the battery lifespan of the vehicle can be extended since the directional antenna can efficiently receive signals due to the characteristic of directionality, compared to a non-directional antenna.

### BRIEF DESCRIPTION OF DRAWINGS

The objects and features of the present invention will become apparent from the following description of embodiments, given in conjunction with the accompanying drawings, in which:

FIGS. 1A and 1B show views of a transmission line for a vehicle in accordance with a first embodiment of the present invention, in which FIG. 1A is a perspective view and FIG. 1B is a right side view;

FIG. 1C depicts a right side view of a transmission line for a vehicle in accordance with a second embodiment of the present invention;

FIG. 2 presents a perspective view of an antenna for a vehicle in accordance with a third embodiment of the present invention;

FIG. 3 is a view showing a dispersion diagram for predicting the characteristics of an antenna for a vehicle in accordance with embodiments of the present invention;

FIG. 4 is a view illustrating the formation of a beam by an antenna for a vehicle in accordance with embodiments of the present invention;

FIG. 5 is a view showing the formation of multibeams using the same frequency and different periods in an antenna for a vehicle in accordance with embodiments of the present invention;

FIG. 6 is a view showing the formation of multibeams using different frequencies and the same period in an antenna for a vehicle in accordance with embodiments of the present invention;

FIG. 7 presents a perspective view of an antenna for a vehicle in accordance with a fourth embodiment of the present invention;

FIG. 8 depicts a perspective view of an antenna for a vehicle in accordance with a fifth embodiment of the present invention;

FIG. 9 offers a perspective view of an antenna for a vehicle in accordance with a sixth embodiment of the present invention;

FIG. 10 shows a perspective view of an antenna for a vehicle in accordance with a seventh embodiment of the present invention;

FIG. 11 illustrates a perspective view of an antenna for a vehicle in accordance with an eighth embodiment of the present invention; and

FIG. 12 is a view showing one example in which transmission lines for a vehicle and antennas for a vehicle are arranged and installed in a vehicle in accordance with embodiments of the present invention.

### BEST MODE FOR CARRYING OUT THE INVENTION

In the following description, well-known functions or constitutions will not be described in detail if they would obscure the invention in unnecessary detail. Further, the terminologies to be described below are defined in consideration of functions in the present invention and may vary depending on a user's or operator's intention or practice. Therefore, the definitions should be understood based on all the contents of the specification.

Hereinafter, embodiments of the present invention will be described with reference to the accompanying drawings which form a part hereof.

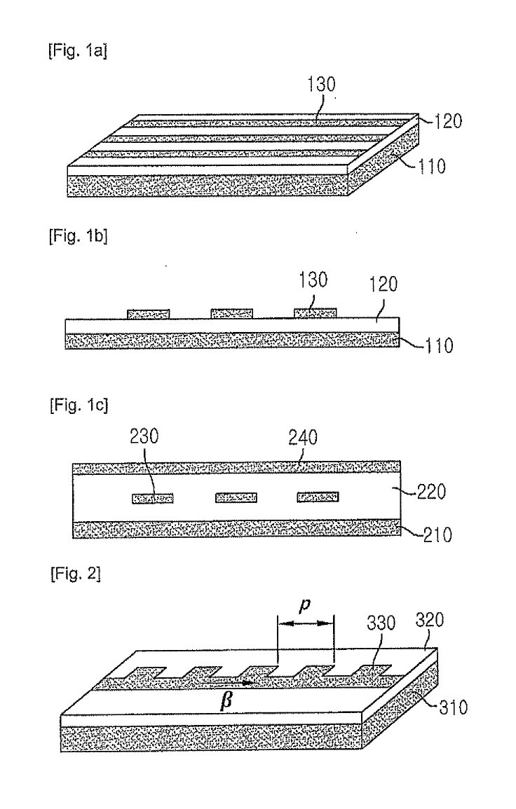

FIGS. 1A and 113 show views of a transmission line for a vehicle in accordance with a first embodiment of the present invention, in which FIG. 1A is a perspective view and FIG. 1B is a right side view.

As shown therein, the transmission line for the vehicle in accordance with the first embodiment of the present invention includes a rolled steel plate 110 forming the body of the vehicle, a painted surface 120 formed on the rolled steel plate 110, and metal lines 130 formed on the painted surface 120.

The rolled steel plate 110 is described as a representative example because a rolling process is usually used in the production of a steel plate to form a vehicle body, and any plate that forms the vehicle body can be used. The rolled steel plate is one example of a steel plate in the following other embodiments as well.

The painted surface 120 functions as a dielectric between the rolled steel plate 110 and the metal lines 130. The function of the dielectric may be a characteristic provided by a typical paint for vehicle painting. The painted surface is one example of the dielectric in the following other embodiments as well.

The metal lines 130 are one example of a conductive line formed of a conductive material. Although using metal as the conductive material is advantageous in terms of conductivity, other materials may also be used. These metal lines 130 can be formed on the painted surface 120 using a coating technique. The metal lines 130 shown in the perspective view of FIG. 1A are depicted without thickness, while the metal lines 130 shown in the right side view of FIG. 1B are depicted to have a predetermined thickness. This indicates that the thickness of the metal lines 130 can change as needed. The metal lines are one example of a conductive line in the following other embodiments as well.

FIG. 1C depicts a view of a transmission line for a vehicle in accordance with a second embodiment of the present invention, which is a right side view.

As depicted therein, the transmission line for the vehicle in accordance with the second embodiment of the present invention includes a rolled steel plate 210 forming the body of the vehicle, a painted surface 220 formed on the rolled steel plate 210, metal lines 230 formed inside the painted surface 220, and a metal plate 240 formed on the painted surface 220.

The metal plate 240 is one example of a conductor formed of a conductive material. Although using metal as the conductive material is advantageous in terms of conductivity, other materials may also be used. This metal plate 240 can be formed on the painted surface 220 using a coating technique. The metal plate is one example of a conductor in the following other embodiments as well.

The transmission line for the vehicle shown in FIGS. 1A and 1B may be a microstrip line, and the transmission line for the vehicle shown in FIG. 1C may be a strip line. The microstrip line in accordance with the first embodiment and the strip line in accordance with the second embodiment may be used as a transmission line serving to transmit radio signals or electric power.

FIG. 2 presents a perspective view of an antenna for a vehicle in accordance with a third embodiment of the present invention.

As shown therein, the antenna for the vehicle in accordance with the third embodiment includes a rolled steel plate 310 forming the body of the vehicle, a painted surface 320 formed on the rolled steel plate 310, and a metal line 330 formed in such a manner as to include a radiating structure on the painted surface 320.

In order for radiation to take place in a given structure, there is a need for a structure where there are discontinuity points or electric power leaks. Also, in order to efficiently receive electric power, a directional antenna is required. An antenna using a periodic pattern can be used as a radiating structure because of its directionality. The periodic pattern indicates a structure where reactive elements are formed with discontinuity in a given transmission line.

The antenna for a vehicle in accordance with the third embodiment of the present invention has a periodic pattern in which one side surface of the metal line 330 is formed in a concavo-convex shape (pulse wave shape), and this periodic pattern can be used as a radiation structure for an antenna.

In this periodic pattern, a period p and a propagation constant β are important parameters that determine the characteristics of the structure. Here, the propagation constant β can be obtained from the following Math FIG. 1 based on a known periodic orbit stability (Floquet) theory:

$$\begin{matrix}Math Figure 1 & \\ {β}_{n} = {β}_{0} + n ( \frac{2 π}{p} ) & [ Math . 1 ]\end{matrix}$$

where n is an integer.

The periodic pattern may have a guiding structure such as a filter, or a radiating structure such as an antenna depending on design. The structure characteristics can be predicted using a dispersion diagram, which is depicted in FIG. 3.

In FIG. 3, the slope (ko/β) of two straight lines indicates the speed of light in a free space. A slow wave region (SWR) is a region having a lower speed than that of light in a free space, and a fast wave region (FWR) is a region having a higher speed than that of light in a free space. In general, as the SWR operates in a guiding structure and the FWR operates in a radiating structure, the periodic pattern of a concavo-convex shape has to be designed to operate in the FWR to use the periodic pattern as an antenna. Using Eq. 1, n corresponding to the FWR (n=−1 in FIG. 3) can be selected from multiple βₙ.

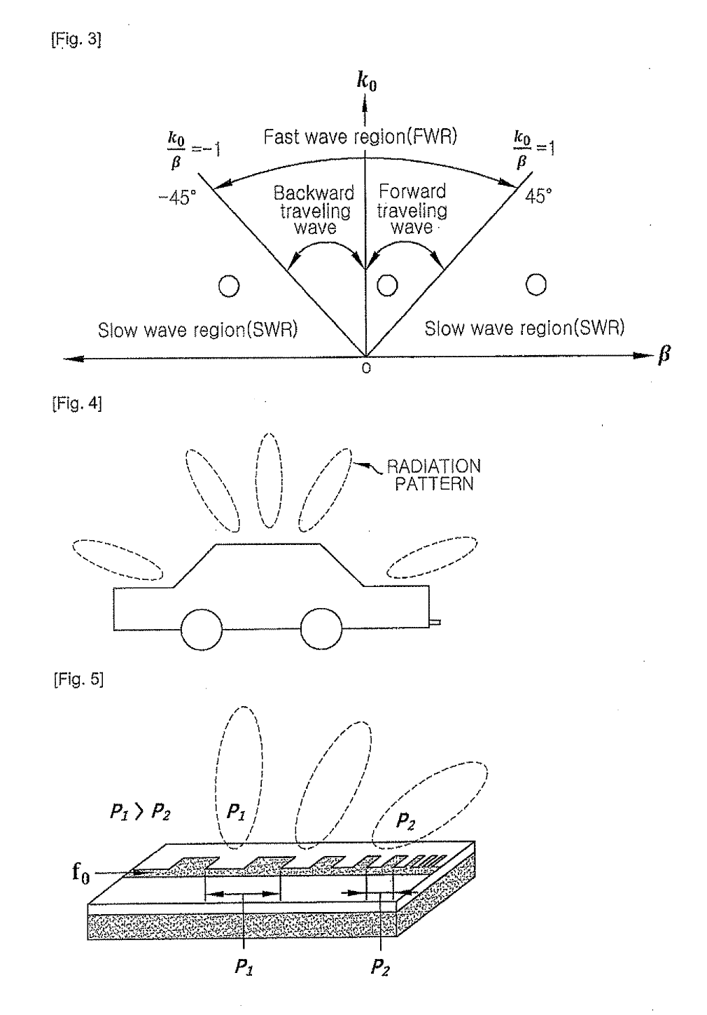

In addition to the periodic pattern of a concavo-convex shape as shown in the embodiment of FIG. 2, various types of patterns can be used to determine the period p and the propagation constant β. When a radio wave travels in a periodic pattern, a leaky wave is generated and leads to radiation, thereby operating the periodic pattern as an antenna. An example of a beam formed in a vehicle when the metal line including the periodic pattern operates as a radiator is shown in FIG. 4. In FIG. 4, the beam is formed at the front, ceiling, and rear portions of the vehicle. Therefore, there exists a portion most receptive to the beam depending on the arrangement of the vehicle and the antenna. In one example, if it is assumed that there is a transmission horn antenna facing the vehicle at a certain distance (e.g., 1 km) in front of the vehicle, most of the transmission power is directed to the front portion of the vehicle. Thus, by placing the antenna at the front portion of the vehicle to an on state and the antennas installed on the ceiling and rear portions thereof to an off state, the electric power can be received most efficiently.

Meanwhile, the angle of beam steering can be adjusted by changing the period p in the embodiment shown in FIG. 2. In one example, if it is assumed that a beam is steered to near 0° at a frequency f0 and in the period p, the beam is steered to the right in a period less than p and to the left in a period greater than p.

FIG. 5 is a view showing the formation of multibeams using the same frequency and different periods. It can be seen that the use of multiple periods, rather than one period, allows the formation of multibeams and the periods gradually decrease. That is, in FIG. 5, a broadside beam is formed at a period p₁ in the front portion, and a beam is formed rightward at a period p₂, which is less than p₁, in the rear portion. Accordingly, the angle of beam steering can be adjusted by adjusting the periods.

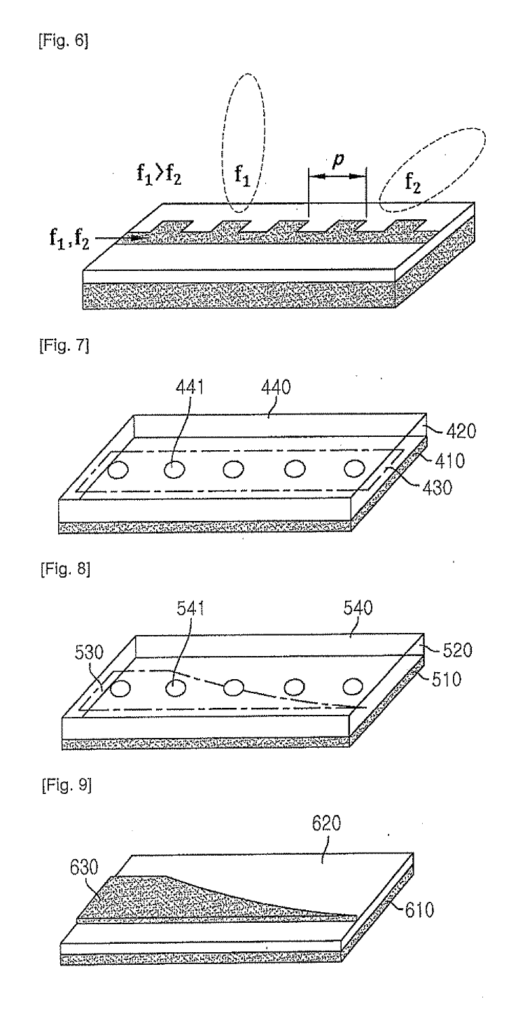

FIG. 6 is a view showing the formation of multibeams using different frequencies f₁ and f₂ and the same period p. The use of different frequencies f₁ and f₂ allows the formation of multibeams even in the same period p. That is, in FIG. 6, if f₁>f₂, the frequency f₁ causes the beam to be steered to near 0° as in the left period p₁ of FIG. 5, whereas the frequency f₂, at which the electric period is less than that at the frequency f₁, causes the beam to be steered rightwards as in the right period p₂ of FIG. 5.

FIGS. 7 to 10 are perspective views showing various embodiments of an antenna for a vehicle in accordance with the present invention.

FIG. 7 is a view illustrating a perspective view of an antenna for a vehicle in accordance with a fourth embodiment of the present invention. The antenna for the vehicle of this embodiment includes a rolled steel plate 410 forming the body of the vehicle, a painted surface 420 formed on the rolled steel plate 410, a metal line 430 formed inside the painted surface 420, and a metal plate 440 formed on the painted surface 420 in such a manner as to include a radiating structure. The radiating structure is composed of a periodic pattern in which reactive elements of the metal plate 440 are formed with discontinuity. In the periodic pattern, apertures 441 are formed at periodic distances in the metal plate 440 and opened to the depth of the metal plate 440.

In the above-described antenna for the vehicle in accordance with the fourth embodiment of the present invention, the metal line 430 serves as a signal line, electromagnetic waves gradually leak through the opened apertures 441 to cause radiation, and characteristics of the antenna are adjusted by adjusting the size and shape of the apertures 441.

FIG. 8 shows a perspective view of an antenna for a vehicle in accordance with a fifth embodiment of the present invention. The antenna for the vehicle of this embodiment includes a rolled steel plate 510 forming the body of the vehicle, a painted surface 520 formed on the rolled steel plate 510, a metal line 530 formed inside the painted surface 520 in such a manner as to include a radiating structure, and a metal plate 540 formed on the painted surface 520 in such a manner as to include a radiating structure.

The radiating structure of the metal plate 540 is composed of a periodic pattern in which reactive elements of the metal plate 540 are formed with discontinuity. In the periodic pattern, apertures 541 are formed at periodic distances on the metal plate 540 and opened to the depth of the metal plate 540. In addition, the radiating structure in this embodiment has one side surface of the metal line 530 formed in a taper shape.

In the above-described antenna for the vehicle in accordance with the fifth embodiment of the present invention, the metal line 530 serves as a signal line, and characteristics of the antenna are adjusted by changing the size and shape of the apertures 541 or adjusting the slope of one side surface of the metal line 530 formed in a taper shape.

Also, the radiating structure of the metal line 530 can be composed of a periodic pattern in which reactive elements of the metal line 530 are formed with discontinuity. Here, in the periodic pattern, one side surface of the metal line 530 is formed in a concavo-convex shape, or, one side surface of the metal line 530 is formed in a concavo-convex shape and other side surface thereof is formed in a taper shape.

Further, in addition to the fourth and fifth embodiments, an antenna for a vehicle may include a rolled steel plate forming the body of the vehicle, a painted surface formed on the rolled steel plate, a metal line formed inside the painted surface in such a manner as to include a radiating structure, and a metal plate formed on the painted surface. In this case, the radiating structure of the metal line is the same as described in the fifth embodiment.

FIG. 9 provides a perspective view of an antenna for a vehicle in accordance with a sixth embodiment of the present invention. The antenna for the vehicle of this embodiment includes a rolled steel plate 610 forming the body of a vehicle, a painted surface 620 formed on the rolled steel plate 610, and a metal line 630 formed on the painted surface 620 in such a manner as to include a radiating structure. The radiating structure has one side surface of the metal line 630 formed in a taper shape.

In the above-described antenna for the vehicle in accordance with the sixth embodiment of the present invention, the metal line 630 serves as a signal line, and characteristics of the antenna are adjusted by changing the slope of one side surface of the metal line 630 formed in a taper shape.

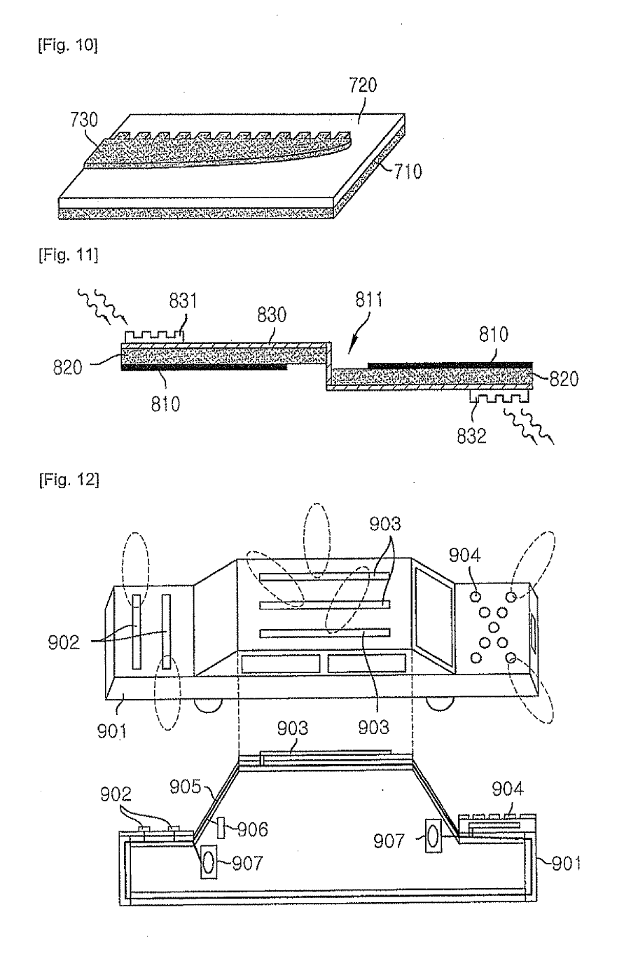

FIG. 10 shows a perspective view of an antenna for a vehicle in accordance with a seventh embodiment of the present invention. The antenna for the vehicle of this embodiment includes a rolled steel plate 710 forming the body of a vehicle, a painted surface 720 formed on the rolled steel plate 710, and a metal line 730 formed on the painted surface 720 in such a manner as to include a radiating structure.

The radiating structure is composed of a periodic pattern in which reactive elements of the metal line 730 are formed with discontinuity. In the periodic pattern, one side surface of the metal line 730 is formed in a concavo-convex shape. Also, the radiating structure may have the other side surface of the metal line 730 formed in a taper shape.

In the above-described antenna for the vehicle in accordance with the seventh embodiment of the present invention, the metal line 730 serves as a signal line, and characteristics of the antenna are adjusted by changing the slope of one side surface of the metal line 730 formed in a taper shape or changing the intervals between the convexes and concaves of the other side surface of the metal line 730 formed in a concavo-convex shape.

In the seventh embodiment of the present invention, both concavo-convex processing and taper processing are applied in order to form a radiating structure on the metal line 730. Such a radiating structure is also applicable to the antenna for the vehicle described with reference to FIG. 8. That is, the other side surface of the metal line 530 can be processed in a concavo-convex shape.

FIG. 11 shows a cross-sectional view of an antenna for a vehicle in accordance with an eighth embodiment of the present invention.

As shown therein, the antenna for the vehicle in accordance with the eighth embodiment of the present invention includes a rolled steel plate 810 forming the body of a vehicle, a metal line 830 exposed to the exterior and interior of the vehicle body via through apertures 811 penetrating the rolled steel plate 810, and a dielectric 820 formed between the metal line 830 at the exterior and the rolled steel plate 810 and between the metal line 830 at the interior and the rolled steel plate 810. The metal line 830 is formed in such a manner as to have a radiating structure in an exterior exposed region 831 and an interior exposed region 832.

The radiating structure is composed of a periodic pattern in which reactive elements of the metal line 830 are formed with discontinuity. In the periodic pattern, one side surface of the metal line 830 is formed in a concavo-convex shape. Here, as in the above-described embodiments, the radiating structure may have one side surface of the metal line 830 formed in a taper shape, or may have one side surface of the metal line 830 formed in a concavo-convex shape and the other side surface thereof formed in a taper shape.

The eighth embodiment of the present invention has a difference in the dielectric 820, compared to the other embodiments. The dielectric has been implemented with a painted surface in the other embodiments, while in the eighth embodiment the dielectric 820 positioned on an outer side (upper side in the drawing) of the rolled steel plate 810 can be implemented with a painted surface but the dielectric 820 positioned on an inner side (lower side in the drawing) of the rolled steel plate 810 is difficult to be implemented with a painted surface. Therefore, in the eighth embodiment of the present invention, a separate dielectric material is filled between the metal line 830 within the vehicle body and the rolled steel plate 810. For example, the dielectric 820 is completed by filling a dielectric material by a burial and bonding process.

In accordance with the eighth embodiment of the present invention, in case where the interior and exterior of the vehicle are electromagnetically shielded, signals can be communicated through the metal line 830. That is, a signal is received through the exterior exposed region 831 of the metal line 830, the received signal is transmitted to the interior of the vehicle through the metal line 830, and the signal is sent to the electronic devices within the vehicle through the interior exposed region 832 of the metal line 830.

FIG. 12 is a view showing one example in which a transmission line for a vehicle and an antenna for a vehicle are arranged and installed in a vehicle in accordance with various embodiments of the present invention.

The entire surface of the body of the vehicle is mostly composed of a rolled steel plate 901 except for glass sections of windows, and antennas 902, 903, and 904 are respectively arranged and installed at three portions: the front, rear, and ceiling of the vehicle.

The antenna 902 positioned at the front portion of the vehicle is formed of multiple microstrip line structures for receiving, for example, a ground-wave digital multimedia broadcasting (DMB), and a microstrip line structure having a good reception state, among the microstrip line structures, is turned on to receive video and audio signals of the ground-wave DMB. The video signal of ground-wave DMB is transmitted to a navigator (combined with a TV and a radio) 906 through a transmission line 905 composed of microstrip lines, and an output audio signal of the navigator 906 is transmitted to a speaker 907 through the transmission line 905 composed of the microstrip lines, thereby allowing a user to watch the ground-wave DMB.

The antenna 903 positioned at the ceiling of the vehicle is formed of multiple microstrip line structures for receiving, for example, a global positioning system (GPS) and a satellite DMB, and a microstrip line structure having a good reception state, among the microstrip line structures, is turned on to receive video and audio signals of the GPS and satellite DMB. The received GPS and satellite DMB video signals are transmitted to the navigator 906 through the transmission line 905 composed of microstrip lines, and an output audio signal of the navigator 906 is transmitted to the speaker 907 through the transmission line 905 composed of the microstrip lines, thereby allowing a user to use the GPS or watch the satellite DMB.

The antenna 904 positioned at the rear portion of the vehicle is formed of a strip line structure for receiving FM and AM radio. FM and AM signals are received through a metal line (including a radiating structure), the received FM and AM signals are transmitted to the navigator 906 through the transmission line 905 composed of microstrip lines, and an output audio signal of the navigator 906 is transmitted to the speaker 907 through the transmission line 905 composed of the microstrip lines, thereby allowing a user to listen to FM and AM radio broadcasts.

In addition to these embodiments, the transmission lines 905 may be used as signal lines of various electronic devices, such as various types of lighting lamps, a window controller, and the like.

While the invention has been shown and described with respect to the embodiments, it will be understood by those skilled in the art that various changes and modification may be made without departing from the scope of the invention as defined in the following claims.

1. A transmission line for a vehicle, comprising:
a steel plate for forming a body of a vehicle;
a dielectric formed on the steel plate; and
a conductive line formed on the dielectric.

2. A transmission line for a vehicle, comprising:
a steel plate for forming a body of a vehicle;
a dielectric formed on the steel plate;
a conductive line formed within the dielectric; and
a conductor formed on the dielectric.

3. The transmission line of claim 1, wherein the dielectric is implemented with a painted surface of the body of the vehicle.

4. An antenna for a vehicle, comprising:
a steel plate for forming a body of a vehicle;
a dielectric formed on the steel plate; and
a conductive line formed on the dielectric in such a manner as to include a radiating structure.

5. The antenna of claim 4, wherein the dielectric is formed with a painted surface of the body of the vehicle.

6. The antenna of claim 4, wherein the radiating structure has a periodic pattern where reactive elements of the conductive line are formed with discontinuity.

7. The antenna of claim 6, wherein, in the period pattern, one side surface of the conductive line is formed in a concavo-convex shape.

8. The antenna of claim 4, wherein the radiating structure has one side surface of the conductive line formed in a taper shape.

9. The antenna of claim 4, wherein the radiating structure has one side surface of the conductive line formed in a concavo-convex shape and the other side surface of the conductive line formed in a taper shape.

10. An antenna for a vehicle comprising:
a steel plate for forming a body of a vehicle;
a dielectric formed on the steel plate;
a conductive line formed inside the dielectric; and
a conductor formed on the dielectric,
wherein at least one of the conductive line and the conductor has a radiating structure.

11. The antenna of claim 10, wherein the dielectric is formed with a painted surface of the body of the vehicle.

12. The antenna of claim 10, wherein the radiating structure has a periodic pattern where reactive elements of the conductive line and/or the conductor are formed with discontinuity.

13. The antenna of claim 12, wherein, in case of the conductive line having the radiating structure, the period pattern includes forming one side surface of the conductive line in a concavo-convex shape.

14. The antenna of claim 12, wherein, in case of the conductor having the radiating structure, the period pattern includes forming apertures at periodic distances in the conductor.

15. The antenna of claim 10, wherein, in case of the conductive line having the radiating structure, the radiating structure has one side surface of the conductive line formed in a taper shape.

16. The antenna of claim 10, wherein, in case of the conductive line having the radiating structure, the radiating structure has one side surface of the conductive line formed in a concavo-convex shape and the other side surface of the conductive line formed in a taper shape.

17. An antenna for a vehicle comprising:
a steel plate for forming a body of a vehicle;
a conductive line exposed to an exterior and an interior of the body of the vehicle via through apertures penetrating the steel plate; and
a dielectric formed between the conductive line at the exterior and the steel plate and between the conductive line at the interior and the steel plate,
wherein the conductive line is formed in such a manner as to include a radiating structure in a region exposed to the exterior and a region exposed to the interior.

18. The antenna of claim 17, wherein the radiating structure has a periodic pattern where reactive elements of the conductive line are formed with discontinuity.

19. The antenna of claim 18, wherein, in the period pattern, one side surface of the conductive line is formed in a concavo-convex shape.

20. The antenna of claim 17, wherein the radiating structure has one side surface of the conductive line formed in a taper shape.

21. The antenna of claim 17, wherein the radiating structure has one side surface of the conductive line formed in a concavo-convex shape and the other side surface of the conductive line formed in a taper shape.

22. The transmission line of claim 2, wherein the dielectric is implemented with a painted surface of the body of the vehicle.
